(19) United States
(12) Patent Application Publication
(10) Pub. No.: US 2025/0253795 A1
(43) Pub. Date: Aug. 7, 2025

(54) METHOD AND SYSTEM FOR FIELD CONTROL OF EXTERNALLY EXCITED SYNCHRONOUS MOTOR

(71) Applicant: Dana Automotive Systems Group, LLC, Maumee, OH (US)

(72) Inventor: Joachim DRUANT, Houthulst (BE)

(21) Appl. No.: 18/432,747

(22) Filed: Feb. 5, 2024

(51) Int. Cl. H02P 27/14; B60L 15/00; B60L 15/20; H02J 7/00

(52) U.S. Cl. CPC H02P 27/14; B60L 15/007; B60L 15/20; H02J 7/0063

(57) ABSTRACT

An electric drive system is disclosed. In one example, the drive system includes a field winding that is electrically coupled to a high voltage bus without any intervening electrical components. Current flow through the field winding is adjusted via adjusting operation of transistors of an inverter so that a magnetic field and electric machine torque may be controlled.

### TECHNICAL FIELD

The present disclosure relates to a system and method for controlling direct current (DC) field control current for a synchronous electric machine.

### BACKGROUND AND SUMMARY

A synchronous electric machine or motor may be applied to propel a vehicle or to perform another operation. The synchronous electric machine provides high efficiency and power output at low speeds. The rotor of the synchronous electric machine includes a field winding that is externally excited (e.g., excited by a power source that is external from the synchronous electric machine). In vehicles, the external excitation for the synchronous electric machine may be provided via a high voltage converter. The high voltage converter may adjust the voltage of a traction battery to a different voltage and provide the different voltage to the field winding of the synchronous electric machine. The high voltage converter may be complex, financially expensive, and it may increase electric losses of the power system. Therefore, it may be desirable to provide a more efficient, less complex, and less financially expensive way of exciting a field winding of a synchronous electric machine.

The inventor herein has recognized the above-mentioned issues and has developed an electric drive system, comprising: a high voltage bus including a high voltage terminal, a center tap terminal, and a low voltage terminal; a three-phase electric machine including a field winding and three armature windings configured in a wye arrangement, where the three armature windings are electrically coupled to form a node, where one lead of the field winding is electrically coupled to the node, and where a second lead of the field winding is electrically coupled to the center tap terminal; and an inverter including three phase outputs, the inverter electrically coupled to the high voltage bus and each of the three armature windings.

By electrically coupling a field winding of an electric machine between a node of three-phase armature windings and a center tap terminal of a high voltage bus, it may be possible to control field current of an electric machine without the financial expense and complexity of a high voltage converter. In particular, transistors of an inverter may be switched to control current flow through the field winding and to control armature current so that a desired or requested driver demand torque may be provided via an electric machine.

The present description may provide several advantages. In particular, the system and method described herein may lower a financial expense of an electric drive system. Further, the present approach may reduce system complexity. In addition, the approach provides may reduce electric power losses as compared to systems that include a separate field voltage control circuit.

It may be understood that the summary above is provided to introduce in simplified form a selection of concepts that are further described in the detailed description. It is not meant to identify key features of the claimed subject matter, the scope of which is defined uniquely by the claims that follow the detailed description. Furthermore, the claimed subject matter is not constrained to implementations that solve any disadvantages noted above or in any part of this disclosure.

The accompanying drawings are incorporated herein as part of the specification. The drawings described herein illustrate embodiments of the presently disclosed subject matter, and are illustrative of selected principles and teachings of the present disclosure. However, the drawings do not illustrate all possible implementations of the presently disclosed subject matter, and are not intended to constrain the scope of the present disclosure in any way.

### BRIEF DESCRIPTION OF THE FIGURES

FIG. 1 is a schematic diagram of an example vehicle driveline that includes an electric machine;

FIG. 2 shows a schematic of an example electric drive system; and

FIG. 3 shows a method for controlling an electric drive system.

### DETAILED DESCRIPTION

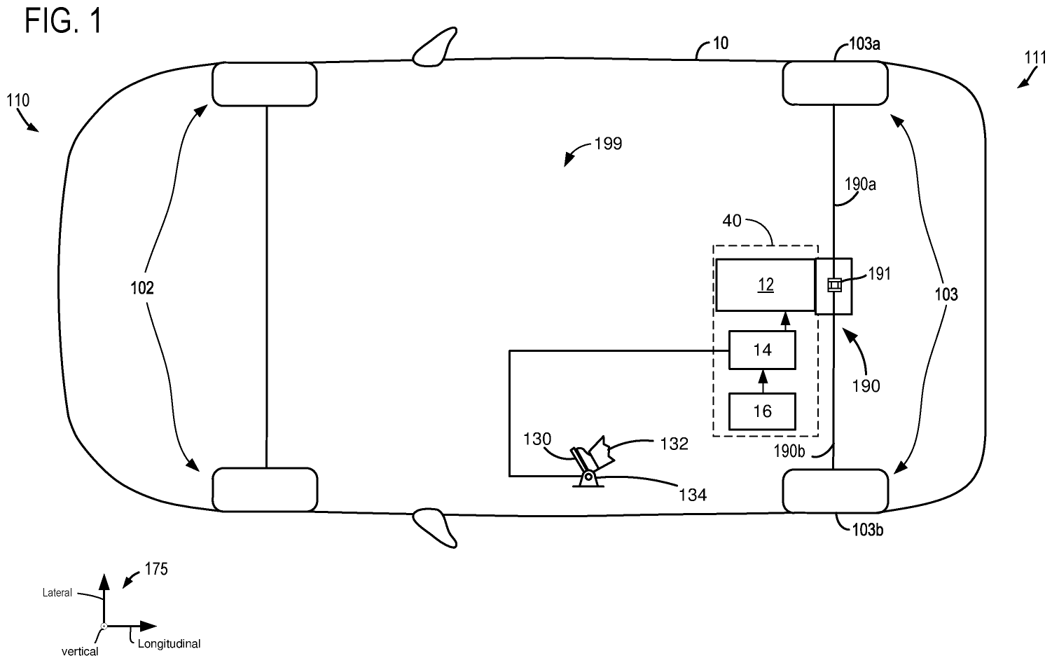

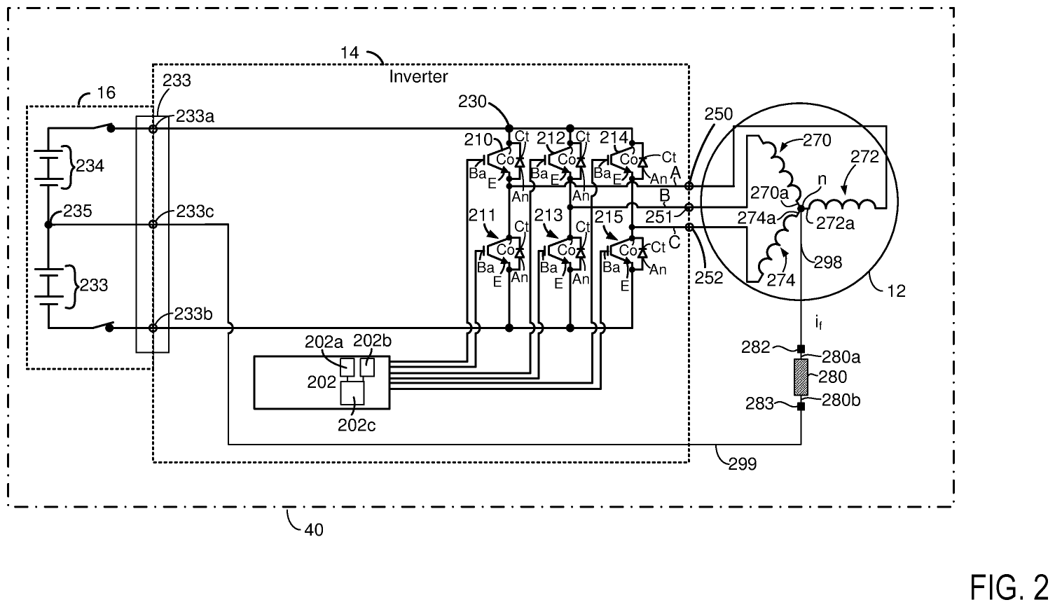

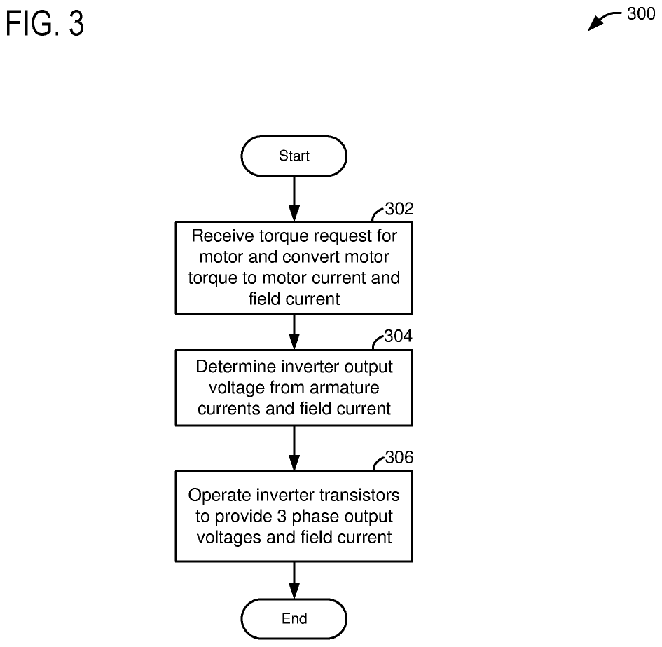

The following description relates to an electric drive system. The electric drive system may be applied to a vehicle or another setting. The electric drive system provides excitation to a field of a synchronous electric machine without a high voltage converter. Elimination of the high voltage converter may simplify the electric drive system and lower electric power consumption. Further, the electric drive system included herein may be simpler to manufacture. The electric drive system may be incorporated into a vehicle as shown in FIG. 1. The electric drive system may include a high voltage bus, an inverter, and an electric machine as shown in FIG. 2. The electric drive system may be operated according to the method of FIG. 3.

FIG. 1 illustrates an example vehicle driveline 199 included in vehicle 10. Vehicle 10 includes a front side 110 and a rear side 111. Vehicle 10 includes front wheels 102 and rear wheels 103. Vehicle 10 includes a propulsion source 12 (e.g., a synchronous electric machine or motor) that may selectively provide propulsive effort to rear axle 190. In other examples, the propulsion source may provide propulsive effort to front wheels 102. Propulsion source 12 is shown mechanically coupled to differential 191, but a transmission may be included between propulsion source 12 and differential 191 in some examples. In other examples, propulsion source 12 may be incorporated into rear axle 190. Electric energy storage device 16 (e.g., a traction battery or capacitor) may be included in and provide high voltage (e.g., greater than 48 VDC) power to electric drive system 40, which also may include propulsion source 12 and inverter 14. Inverter 14 may convert direct current (DC) from electric energy storage device 16 to alternating current (AC). The AC may be supplied from inverter 14 to propulsion source 12. Alternatively, inverter 14 may convert AC from propulsion source 12 to DC that is supplied to electric energy storage device 16. Inverter 14 may be a three phase half-bridge inverter as shown in FIG. 2.

Rear axle 190 comprises two half shafts, including a first or right haft shaft 190a and a second or left half shaft 190b. The rear axle 190 may be an integrated axle that includes a differential gear set 191. Differential gear set 191 may be open when vehicle 10 is traveling on roads and negotiating curves so that right rear wheel 103a may rotate at a different speed than left rear wheel 103b. The orientation of vehicle 10 may be referenced to axis 175.

Turning now to FIG. 2, a detailed view of electric drive system 40 is shown. Electric drive system includes an inverter 14 is shown electrically coupled to electric energy storage device 16 (e.g., traction battery), the inverter 14 that is directly electrically coupled to electric machine 126 via phase voltage output terminals 250, 251, and 252. With regard to FIG. 2, “directly electrically coupled” refers to a first electric component that is electrically coupled to a second electric component with no intervening electric components (e.g., integrated circuits, transistors, resistors, capacitors, inductors), excepting electric conductors and terminals. Electric conductors are shown in FIG. 2 as solid lines. Nodes 230 show connections between the various conductors, but not each node is labeled.

In this example, electric energy storage device 16 includes a plurality of battery cells that are connected in series to increase a voltage of electric energy storage device 16. Electric energy storage device 16 is shown with a first group of battery cells 234 and a second group of battery cells 233. The first group of battery cells is configured to have a first output voltage (e.g., 400 volts) when fully charged and the second group of battery cells is configured to have the same output voltage as the first group of battery cells. Thus, when the first and second groups are combined in series as shown in FIG. 2, the total voltage of the battery pack is the voltage of the first battery group plus the voltage of the second battery group. The electric energy storage device 16 is electrically coupled to a high voltage bus 233 that includes a higher voltage battery terminal 233a, a lower voltage battery terminal 233b, and a middle voltage terminal 133c. The higher voltage battery terminal 233a is directly electrically coupled to the first group of battery cells 234. The middle voltage terminal 233c is directly electrically coupled to the first group of battery cells 234 and the second group of battery cells 233. The lower voltage battery terminal 233b is directly electrically coupled to the second group of battery cells 233. The middle voltage terminal may be referred to as a center tap of the battery as it has a voltage that is one half of the traction battery voltage relative to the voltage of the lower voltage battery terminal 233b.

Inverter 14 includes a controller 202 that may communicate with a vehicle controller (not shown) or other controller. Controller 202 is directly electrically coupled to bases of transistors 210-215 of inverter 14. Transistors 210-215 are operated in switching mode and these transistors may be referred to as switches. Controller 202 may supply control signals to independently activate and deactivate transistors 210-215 so that transistor may allow electric current to flow or not to flow. Controller 202 includes inputs and outputs 202a (e.g., digital inputs, digital outputs, analog inputs, analog outputs), memory 202b (e.g., non-transitory memory, random-access memory, and read exclusively), and processor 202c.

Transistors 210-215 are shown as insulated gate bipolar transistors (IGBT), but in alternative configurations, these transistors may be metal oxide field effect transistors (MOSFETs), field effect transistors (FETs), or other known types of transistors. Controller 202 may activate IGBTs (e.g., permit current flow through the transistor) via supplying a higher potential voltage to bases of transistors 210-215. Controller 202 may deactivate IGBTs (e.g., cease current flow through the transistor) via supplying a lower potential voltage to bases of transistors 210-215. Bases of the transistors are indicted by the letters “Ba.” Collectors of the transistors are indicated by letters “Co.” Emitters of the transistors are indicated by letters “E.” Each transistor includes a diode and the diodes are biased to permit current flow from the transistor's emitter lead to the transistor's collector lead. The diode's anodes are labeled An and the diode's cathodes are labeled Ct. Inverter 14 also includes a filter capacitor 231. Inverter 14 includes three phase voltage outputs including first phase voltage output (phase A output-indicated as A), a second phase voltage output (phase B output-indicated as B), and a third phase voltage output (phase C output—indicated as C). The A phase is electrically coupled to A phase voltage output terminal 250, the B phase is electrically coupled to B phase voltage output terminal 251, and the C phase is electrically coupled to C phase voltage output terminal 252. The collectors of transistors 210, 212, and 214 are directly electrically coupled to the high voltage bus high voltage terminal 233a. The emitters of transistors 211, 213, and 215 are directly electrically coupled to the lower voltage battery terminal 233b of the high voltage bus. Inverter 14 is also shown being directly electrically coupled to armature phase windings 270, 272, and 274 of propulsion source 12 (e.g., a three phase electric machine that may be operated as a motor or generator).

Propulsion source 12 includes a rotor winding 280 that includes a first lead 280a and a second lead 208b. The rotor winding leads are electrically coupled to slip rings 282 and 283 that allow electric current to flow into and out of rotor winding 280 while a rotor of propulsion source 12 is rotating. The armature of propulsion source 12 also includes armature winding 270, which is the B phase winding, armature winding 272, which is the A phase winding, and armature winding 274, which is the C phase winding. Propulsion source 12 is constructed with armature windings 270-274 in a wye configuration where the armature windings are tied together at node n. In particular, leads 270a, 272a, and 274a are tied together to form node n.

The voltage across A phase winding is Van. The voltage across B phase winding is Vbn. The voltage across C phase winding is Ven. The A phase winding is directly electrically coupled to the A phase voltage output terminal 250. The B phase winding is directly electrically coupled to the B phase voltage output terminal 251. The C phase winding is directly electrically coupled to the C phase voltage output terminal 252. First lead 280a is directly electrically coupled to slip ring 282 and slip ring 282 is directly electrically coupled to node n via conductor 298. Second lead 280b is directly electrically coupled to slip ring 283 and slip ring 283 is directly electrically coupled to middle voltage terminal 233c of high voltage bus 233 via conductor 299.

The voltage difference between the middle voltage terminal 233c and the first phase voltage output A is Vao. The voltage difference between the middle voltage terminal 233c and the second phase voltage output B is Vbo. The voltage difference between the middle voltage terminal 233c and the third phase voltage output C is Vco. The voltage between the middle voltage terminal 233c and the voltage at node n is Von. The voltage across the field winding is Vf. The voltage difference between the node n and the first phase voltage output A is Van. The voltage difference between the node n and the second phase voltage output B is Vbn. The voltage difference between the node n and the third phase voltage output Cis Vcn. The voltage across the field winding Vf is-Von.

A vehicle operator 132 may input a driver demand request (e.g., a torque request) via a driver demand pedal 130. A driver demand pedal position sensor 134 provides a signal that is indicative of driver demand pedal position to a controller. In this example, the controller is part of inverter 14, but in other examples the controller may be a vehicle controller or another controller. The controller may determine a torque request based on the driver demand pedal position and vehicle speed.

Thus, the system of FIG. 2 supplies a voltage from a center tap of a traction battery to a field winding of a synchronous electric machine via a high voltage bus. Transistors 210-215 may be switched on and off to control a voltage at node n, and the voltage at node n and the voltage from the center tap of the traction battery control the current flow through the field winding. The transistors 210-215 are also operated by controller applying pulse width modulation to control the voltages that are applied to the electric machine armature windings. The voltage supplied to the armature windings and the field current are adjusted such that the propulsion source generates a driver demand torque (e.g., a torque that is requested by a vehicle operator by way of a driver demand pedal.

Thus, the system of FIGS. 1 and 2 provides for an electric drive system, comprising: a high voltage bus including a high voltage terminal, a center tap terminal, and a low voltage terminal; a three-phase electric machine including a field winding and three armature windings configured in a wye arrangement, where the three armature windings are electrically coupled to form a node, where one lead of the field winding is electrically coupled to the node, and where a second lead of the field winding is electrically coupled to the center tap terminal; and an inverter including three phase outputs, the inverter electrically coupled to the high voltage bus and each of the three armature windings. In a first example, the electric drive system includes where the center tap terminal delivers a voltage that is half a voltage of an actual total voltage of a traction battery of a vehicle that includes the electric drive system. In a second example that may include the first example, the electric drive system includes where the first lead is coupled to a slip ring and the second lead is coupled to a slip ring. In a third example that may include one or both of the first and second examples, the electric drive system further comprises a plurality of transistors coupled to the three phase outputs. In a four example that may include one or more of the first through third examples, the electric drive system includes where the three phase outputs deliver three different voltages generated from a traction battery. In a fifth example that may include one or more of the first through fourth examples, the electric drive system further comprises one or more controllers, the one or more controllers including executable instructions stored in non-transitory memory that cause the one or more controllers to operate the plurality of transistors to control a current flow through the field winding and a current flow through the three armature windings. In a sixth example that may include one or more of the first through fifth examples, the electric drive system includes where the current flow through the field windings and the current flow through the three armature windings is controlled via switching operating states of the plurality of transistors. In a seventh example that may include one or more of the first through sixth examples, the electric drive system further comprises additional executable instructions that cause the controller to adjust a voltage at the node via the plurality of transistors.

The system of FIGS. 1 and 2 also provides for an electric drive system, comprising: a high voltage bus including a high voltage terminal, a center tap terminal, and a low voltage terminal; a three-phase electric machine including a field winding and three armature windings configured in a wye arrangement, where the three armature windings are electrically coupled to form a node, where one lead of the field winding is electrically coupled to the node, and where a second lead of the field winding is electrically coupled to the center tap terminal; an inverter including three phase outputs, the inverter electrically coupled to the high voltage bus and each of the three armature windings; and one or more controllers including executable instructions stored in non-transitory memory that cause the one or more controllers to adjust a voltage present at the node. In a first example, the electric drive system includes where the inverter includes three groups of transistors arranged in parallel, each of the three groups including two transistors arranged in series. In a second example that may include the first example, the electric drive system includes where the executable instructions stored in non-transitory memory cause the controller to operate the three groups of transistors to adjust the voltage present at the node. In a third example that may include one or both of the first and second examples, the electric drive system further comprises a traction battery electrically coupled to the high voltage bus. In a fourth example that may include one or more of the first through third examples, the electric drive system includes additional instructions to deliver a driver demand torque via the three-phase electric machine.

Referring now to FIG. 3, an example method 300 for operating an electric machine is shown. The method described herein may be provided via the circuitry shown in FIGS. 1 and 2. Portions of method 300 may be stored as executable instructions stored in non-transitory memory of a controller while other portions of method 300 may be provided by virtue of a design of circuitry.

At 302, method 300 receives a torque request for a propulsion source or electric machine. In one example, the torque request is received from a driver demand pedal position sensor. The torque request is converted into an amount of electric current that is to be supplied to the electric machine. In one example, the amount of current may be determined via a look-up table or a model of the electric machine that has requested torque and present electric machine speed as inputs and field current and armature currents for each of the three phases is the output. Method 300 proceeds to 304.

At 304, method 300 determines inverter output voltage for each of the three phases according to the requested field current and the armature current that supplies the driver demand torque. The zero-sequence voltage (e.g., Vno—the voltage at the node n with respect to the voltage at the center tap of the traction battery) may be controlled independently from the phase voltages (e.g., Van—the voltage output at the phase A voltage output of the inverter with respect to the voltage at node n; Vbn—the voltage output at the phase B voltage output of the inverter with respect to the voltage at the node n; and Ven—the voltage output at the phase C voltage output of the inverter with respect to the voltage at node n) so that the inverter modulation index may be adjusted. The relationships between the inverter output voltages and the field voltage that is determined from the requested field current may be expressed via the following equations:

$${V}_{a n} = {V}_{a o} + {V}_{o n} \qquad ( 1 )$$

$${V}_{b n} = {V}_{b o} + {V}_{o n} \qquad ( 2 )$$

$${V}_{c n} = {V}_{c o} + {V}_{o n} \qquad ( 3 )$$

$${V}_{f} = - {V}_{o n} \qquad ( 4 )$$

where Van, Vbn, and Von are as previously described, Vao—the voltage output at the phase A voltage output of the inverter with respect to the voltage at the center tap of the traction battery; Vbn—the voltage output at the phase B voltage output of the inverter with respect to the voltage at the center tap of the traction battery; and Ven—the voltage output at the phase C voltage output of the inverter with respect to the voltage at the center tap of the traction battery, Vf is the voltage across the field winding which is minus the voltage at the node n with respect to the voltage at the center tap of the traction battery. Method 300 determines the voltage drop across the field winding to that provides the requested field current I_{f} where the field current may be determined via the equation:

$${I}_{f} = \frac{1}{L} {\int }_{0}^{T} v dt + {i}_{0} ,$$

where L is the inductance of the field winding, i₀ is the initial field winding current, and T is the end time of the integration interval. Equations 1-4 may be solved to determine the three phase output voltages for the inverter. Method 300 proceeds to 306.

At 306, method 300 causes transistors within the inverter (e.g., 210-215) to open close via pulse width modulation to generate the three phase voltages at the output of the inverter. Method 300 proceeds to exit.

In this way, field current flowing through a rotor of a synchronous electric machine may be adjusted via controlling an inverter at the same time that the inverter controls the electric machine to generate a driver demand torque. Consequently, a second inverter or power converter is not applied to generate field current for the rotor.

Thus, the method of FIG. 3 provides for a method for operating an electric drive system, comprising: adjusting a phase output voltage of an inverter in response to a difference in a voltage across a phase winding and a voltage between a node and a center tap terminal of a high voltage bus. In a first example, the method includes where the phase output voltage is adjusted via controlling one or more transistors. In a second example that may include the first example, the method further comprises supplying the phase output voltage to a winding of a motor. In a third example that may include one or both of the first and second examples, the method further comprises adjusting current flow through a field winding of the motor. In a fourth example that may include one or more of the first through third examples, the method includes where the winding is an armature winding. In a fifth example that may include one or more of the first through fourth examples, the method includes where adjusting current flow through the field winding includes adjusting operation of the one or more transistors. In a sixth example that may include one or more of the first through sixth examples, the method includes where the node is where leads of three phase windings are electrically coupled together with no intervening electrical components.

Note that the example control and estimation routines included herein can be used with various powertrain and/or vehicle system configurations. The control methods and routines disclosed herein may be stored as executable instructions in non-transitory memory and may be carried out by the control system including the controller in combination with the various sensors, actuators, and other vehicle hardware. Further, portions of the methods may be physical actions taken in the real world to change a state of a device. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example examples described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller. One or more of the method steps described herein may be omitted if desired.

It will be appreciated that the configurations and routines disclosed herein are exemplary in nature, and that these specific examples are not to be considered in a constraining sense, because numerous variations are possible. For example, the above technology can be applied to powertrains that include different types of propulsion sources including different types of electric machines and transmissions. Further, the circuitry described herein may be modified or configured in an alternative way without departing from the scope and/or breadth of the methods and systems described herein. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims may be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric drive system, comprising:
a high voltage bus including a high voltage terminal, a center tap terminal, and a low voltage terminal;
a three-phase electric machine including a field winding and three armature windings configured in a wye arrangement, where the three armature windings are electrically coupled to form a node, where a first lead of the field winding is electrically coupled to the node, and where a second lead of the field winding is electrically coupled to the center tap terminal; and
an inverter including three phase outputs, the inverter electrically coupled to the high voltage bus and each of the three armature windings.

2. The electric drive system of claim 1, where the center tap terminal delivers a voltage that is half a voltage of an actual total voltage of a traction battery of a vehicle that includes the electric drive system.

3. The electric drive system of claim 1, where the first lead is coupled to a first slip ring and the second lead is coupled to a second slip ring.

4. The electric drive system of claim 1, further comprising a plurality of transistors coupled to the three phase outputs.

5. The electric drive system of claim 4, where the three phase outputs deliver three different voltages generated from a traction battery.

6. The electric drive system of claim 4, further comprising one or more controllers, the one or more controllers including executable instructions stored in non-transitory memory that cause the one or more controllers to operate the plurality of transistors to control a current flow through the field winding and current flow through the three armature windings.

7. The electric drive system of claim 6, where the current flow through the field winding and the current flow through the three armature windings is controlled via switching operating states of the plurality of transistors.

8. The electric drive system of claim 7, further comprising additional executable instructions that cause the one or more controllers to adjust a voltage at the node via the plurality of transistors.

9. A method for operating an electric drive system, comprising:
adjusting a phase output voltage of an inverter in response to a difference in a voltage across a phase winding and a voltage between a node and a center tap terminal of a high voltage bus.

10. The method of claim 9, where the phase output voltage is adjusted via controlling one or more transistors.

11. The method of claim 10, further comprising supplying the phase output voltage to a winding of a motor.

12. The method of claim 11, further comprising adjusting current flow through a field winding of the motor.

13. The method of claim 12, where the winding is an armature winding.

14. The method of claim 13, where adjusting current flow through the field winding includes adjusting operation of the one or more transistors.

15. The method of claim 9, where the node is where leads of three phase windings are electrically coupled together with no intervening electrical components.

16. An electric drive system, comprising:
a high voltage bus including a high voltage terminal, a center tap terminal, and a low voltage terminal;
a three-phase electric machine including a field winding and three armature windings configured in a wye arrangement, where the three armature windings are electrically coupled to form a node, where one lead of the field winding is electrically coupled to the node, and where a second lead of the field winding is electrically coupled to the center tap terminal;
an inverter including three phase outputs, the inverter electrically coupled to the high voltage bus and each of the three armature windings; and
one or more controllers including executable instructions stored in non-transitory memory that cause the one or more controllers to adjust a voltage present at the node.

17. The electric drive system of claim 16, where the inverter includes three groups of transistors arranged in parallel, each of the three groups including two transistors arranged in series.

18. The electric drive system of claim 17, where the executable instructions stored in non-transitory memory cause the one or more controllers to operate the three groups of transistors to adjust the voltage present at the node.

19. The electric drive system of claim 18, further comprising a traction battery electrically coupled to the high voltage bus.

20. The electric drive system of claim 19, further comprising additional instructions to deliver a driver demand torque via the three-phase electric machine.
